(19) United States
(12) Patent Application Publication
(10) Pub. No.: US 2002/0116394 A1
(43) Pub. Date: Aug. 22, 2002

(54) Meta data category and a method of building an information portal

(76) Inventor: Markus Gerardus Leonardus Maria Van Doorn, Eindhoven (NL)

Correspondence Address: U.S. Philips Corporation, 580 White Plains Road, Tarrytown, NY, 10591, US

(21) Appl. No.: 10/024,776

(22) Filed: Dec. 20, 2001

(30) Foreign Application Priority Data
Dec. 22, 2000 (EP) 00204794.2

(51) Int. Cl. G06F 7/00

(52) U.S. Cl. 707/104.1

(57) ABSTRACT

There is disclosed a new meta data category and a method of building an information portal in accordance with a user profile utilizing the new meta data category. Up until now, it has been very difficult for users of the world wide web to locate services and applications over the web, since search engines index web pages on a content basis, rather than on any functionality basis. The present application proposals a new meta data category including functional identifiers. Such functional identifiers would be written in a dedicated task description language (14) whose sole aim is to provide an adequate indexing of applications/services in a functional manner. The invention further relates to the generation of an information portal utilizing the new meta data category.

The invention relates to the Internet (also known as the World Wide Web WWW). In particular, the invention relates to the provision of a new meta data category and a method of building an information portal and personalizing that portal in accordance with a user profile and utilizing the new meta data category.

The Internet is a large network of computers in which a user may access information from one of any number of Web servers over the network, such Web servers being physically located anywhere in the world. Essentially, the user makes a request over the Internet and the relevant Web server passes the requested information to the user. The information available on such Web servers may comprise text, graphics, video or audio. In addition, Web servers may provide access to user executable applications. Because of the vast amount of information stored on Web servers and accessible via the Internet, users can employ search engines to find information which is relevant to their particular needs. In order for a search engine to carry out this particular function the information needs to be indexed or stored in database structures.

Web portals offer search engine functionality and also access to a predefined set of applications available locally or distributed on Web servers across the globe. There are currently no means available to search the behaviour or functionality of applications presented by a portal. As the number of applications available is growing rapidly it will become increasingly difficult to find the right application or service on the Internet in the future. This problem is referred to as “application overload”.

It is a first aim of embodiments of the present invention to provide a means for identifying applications or services relevant to a particular user.

It is another aim of embodiments of the present invention to provide a method for generating a portal to information and applications on the Internet based on a personal profile and/or feedback from user queries to reduce application overload.

According to a first aspect of the invention, there is provided a meta data category specifying types of web applications and services.

Such provision brings a new versatility to the web and is a major help in overcoming the application overload problem.

Preferably, within said meta data category a plurality of functional identifiers may be present, each functional identifier denoting a specific type of application or service available via the world wide web.

The functional identifiers are building blocks for a task description language for describing the functionality of a web application or service. A web application document would contain a piece of text (or a link to a separate document) written in such a task description language.

Providing a functional identifier for web based applications and services supplements existing content identifiers and thereby helps users locate specific services/applications.

Preferably, each functional identifier comprises one or more keywords identifying a type of application or service being offered by a web based provider.

Key word identifiers enable efficient classification by search engines.

Preferably, functional identifiers are written in a task description language which describes the functionality of the application or service.

Preferably, the meta data category is provided in a searchable area of a web page, preferably in a header region. Alternatively, it may be provided as part of a URL (Uniform Resource Locator).

Providing the meta data category in the meta header or other searchable region enables functional identifiers to be read by dedicated web crawlers when building up search terms for use with search engines etc.

Typical applications or services identified by such functional identifiers may, for instance, comprise manufacturing, sales or repairing of physical items, the provision of professional, domestic or other services, etc.

According to a second aspect of the invention, there is provided a method of building up a portal to information and applications on a network comprising retrieving content from one or more data sources that match the user profile and presenting the retrieved content to a user's web browser, wherein the retrieved content presented to the user includes information concerning web applications and/or services, said information being retrieved on the basis of web application and/or service types.

Providing such a portal enables for the first time an effective transmission of information to users which identifies services relevant to a user's needs or interests.

Preferably, the method further comprises analysing an input user query to detect a desire for retrieving web applications and/or services, retrieving content from one or more data sources that match the user query and presenting the retrieved content to the users web browser.

Preferably, displayed results presented to the user via the user's web browser comprises conventional content as well as information concerning web applications/services and such conventional content and the information are merged prior to presentation to the user—merging may be accomplished in a generation module. Retrieved applications may be regarded as functional content.

The step(s) of retrieving content from data sources may comprise filtering content and applications from said one or more data sources to match such content with a user query or user profile.

Preferably, the web browser is configured to deliver information to the user, based on a user profile, to personalise the portal.

Personalisation does not have to happen inside the browser, the presentation in the form of a web document containing the personalised portal interface is preferably generated on the server. However, the user profile may be used to personalise the look-and-feel of the browser.

Preferably, the user profile is constructed based upon implicit feedback from information originating from the user and delivered by the browser. Such implicit feedback may comprise determining patterns of user behaviour from user input to the browser so as to build up and modify knowledge about the user and store such knowledge in the user profile. Such knowledge may also comprise knowledge about domain, platform and general presentation styles etc.

In the step of retrieving content, content may be retrieved based directly upon the user query to retrieve applications.

In the step of retrieving content, said content is preferably retrieved based directly upon a user query and such content includes one or more links to application and/or service providers identified by said one or more functional identifiers.

Preferably, the meta data category is a meta data category in accordance with the first aspect of the invention.

For a better understanding of the invention, and to show how embodiments for the same may be carried into effect, reference will now be made by way of example, to the accompanying diagrammatic drawings in which:

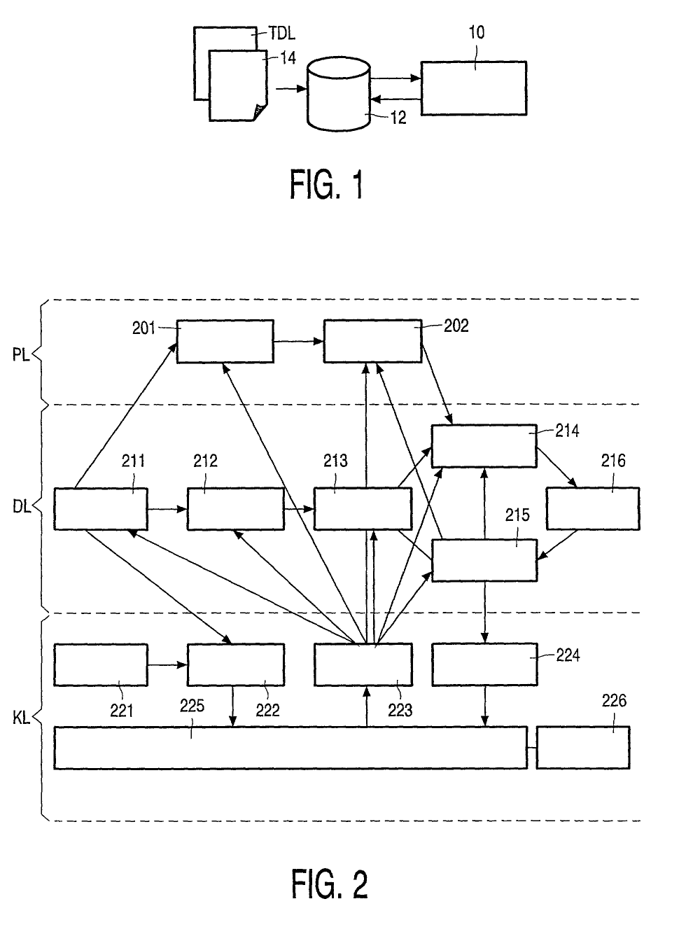

FIG. 1 is a schematic diagram illustrating the indexing and retrieval of Web applications and services using meta-data described in a task-description language; and

FIG. 2 shows a schematic diagram illustrating an architecture for information processing on the Web according to an aspect of the present invention.

As mentioned in the discussion of the prior art, meta data categories currently employed tend to designate content of web pages or types of content present on web pages (e.g. whether video is present, audio etc.). To address the problem of application overload, the inventors propose a new meta data category which provides functional indications according to applications or services being offered via a web site. Such functional indications can thereby provide a task-based indexing of web services, which is extremely valuable for information portals. An example of such an information portal may be found at the URLs (Uniform Resource Locators) www.yahoo.com, www.altavista.com etc. It is possible to personalise such portals to an extent so as to tailor a general web portal into something which is a little more specific (e.g. My Yahoo, My Excite).

However, personalisation in terms of retrieving information concerning functionality and services offered by the web is at present impractical.

To generate a portal in accordance with an aim of the present invention requires the existence of an appropriate meta-data category which designates “functionality”. With the use of meta-data, Web applications that show complex behavior are regarded as objects described by meta-data, and the descriptions stored in database tables to be retrieved later. This can be accomplished if textual descriptions are added to existing uniform resource locators (URLs) or a specific field is added to a header region of a web page.

There is shown below a typical header region written in HTML (Hyper Text Markup Language) of a conventional web site:

<HTML>
<HEAD>
<META name=”description” content= “xxxxxxxxxx”>
<TITLE>xxxxxx</TITLE>
</HEAD>

In the above example, there is shown a content oriented meta data listing provided in an HTML header region of a web page. In the newly proposed system, functional, rather than content type meta data is included in the header region.

Such meta data may alternatively be included in any other area of the web page, such as in the body region enclosed in special XML tags—so long as it does not affect the presentation of the web document in a browser and can be understood by machines (crawlers, indexers).

In a preferred embodiment of the present invention a functionally oriented meta-data category describing Web applications is written in a task-description language (TDL) that describes the functionality of the Web application or service as one or more functional identifiers. These functional identifiers can be indexed or stored into database tables according to the functions or types of applications that they represent and be retrieved by the user, as shown in FIG. 1.

FIG. 1 is a schematic diagram illustrating the indexing and retrieval of Web applications and services using meta-data described in a task-description language in which there is shown a browser 10 and a database 12 built up of task-description language (TDL) documents 14.

The user inputs a task query to their browser, which in accordance with their personal profile and the current query searches the task-description language (TDL) documents indexed in a database, and presents the user with relevant applications. The browser can then update the user profile based on knowledge of the input query and/or the applications selected by the user from the list presented.

The user input could also be converted into TDL by a user input query formulation unit (using a Graphical User Interface for example) if the TDL language is too complex for ordinary users.

A suitable format for the meta-data is the Resource Description Framework (RDF) which is under development by the World Wide Web consortium (W3C) (see www.w3.org/RDF/), but any similar and widely acceptable language could be used to record and store the necessary meta-data. The database 12 of TDL documents 14 is compiled by a Web crawler that looks for new or modified content on the Web to index. Web applications and services must be represented in a machine understandable way for the Web crawler to correctly index them, and this functionality is provided by the same meta-data.

FIG. 2 shows a high level overview of the architecture of the new semi-automatic personalised portal generation and presentation process. The architecture consists of three layers; a knowledge layer KL that consists of knowledge bases on the Web, a document layer DL that represents, retrieves and presents information on the Web using the knowledge layer KL and a portal layer PL which delivers personalised Web applications and services to different users. The portal layer PL comprises an application indexing block 201 and an application retrieval block 202. The document layer DL comprises a document discovery block 211, a document indexing block 212, a database management system and/or information retrieval block 213 (DBMS/IR), a presentation generation block 214, a user input analysis block 215 and a Web browser 216. The knowledge layer KL comprises a knowledge discovery block 221, a knowledge extraction block 222, a knowledge reasoning block 223, a knowledge modification block 224, knowledge bases 225 and a locally stored user profile block 226.

The Web browser 216 allows a user to interact with Web content. In most cases, the Web browser 216 will be a software component that displays Web content, although it does not necessarily have to display such content on a screen, as speech dialogue systems and Braille systems also allow users to interact with Web content through specifically designed interfaces. The Web browser 216 supplies implicit feedback information about the user to the user input analysis block 215 which identifies patterns in the users behaviour that can be used to modify knowledge about the user. Also, the browser 216 may pass other information to the user input analysis block 215 regarding the platform on which it is running, the users domain and general presentation styles preferred by the user etc. The Web browser 216 may in addition be adapted to allow the user to provide explicit feedback about the type of application and/or information required. The user input analysis block 215 controls the creation and maintenance of a personalised view on the Web that best matches the users requirements at a given point in time.

The user input analysis block 215 then formulates a query and passes it to the DBMS/IR block 213 which determines the content or applications that best match that query and feeds this information to the presentation generation block 214.

The presentation generation block 214 receives information from the DBMS/IR block 213 and the application retrieval block 202 and filters this information to create a portal which gives a coherent view on information that matches the users information needs. The presentation generation block 214 can then supply a personalised set of hyper-linked documents, which can comprise plain text documents, multimedia objects or Web applications to the Web browser 216 for communication with the user.

At no point in the procedure is the user concerned by details of where information is gathered from. The document discovery block 211 is a Web crawler, which represents documents and applications on the Web in a machine understandable way and passes reference to them to the document indexing block 212 and application indexing block 201. Text documents may be indexed using keywords, but the use of meta-data is required to provide suitable identification for applications and thereby allow them to be indexed.

The ability to adapt to a users personal needs by incorporating knowledge gained implicitly over time is useful to some degree for all the components shown in FIG. 2. For example, the document discovery block 211 might be personalised to search for information on applications in a specific domain. However, before knowledge can be used to adapt these processes, it must first be extracted automatically, or modelled manually. The knowledge discovery block 221 locates meta-data on the Web that can be extracted or modelled by the knowledge extraction block 222, this knowledge is then placed in the knowledge bases 225. The knowledge bases 225 can either store information locally, or on the Web depending on the type of knowledge, the amount of knowledge, the performance required in accessing the knowledge, the privacy of the knowledge or other factors.

Besides direct acquisition of knowledge from documents or profiles on the Web, knowledge can also be obtained and updated through implicit, explicit or social input from the users which is analysed by the user input analysis block 215 and then passed to the knowledge modification block 224 for storage in the knowledge bases 225. This process ensures that the knowledge stored in the knowledge bases 225 is up to date, and therefore useful to when passed to the other components shown in FIG. 2. The knowledge reasoning block 223 retrieves knowledge from the knowledge bases 225 and distributes it to the document discovery block 211, the document indexing block 212, the DBMS/IR block 213, the application indexing block 201, the presentation generation block 214, and the user input analysis block 215 which can then all use this knowledge to adapt accordingly.

From the above, it will be evident to the man skilled in the art that the present invention provides an effective form of categorising applications or services which are offered by the web according to functionality. Also, based on the newly proposed meta data category designating such functionality there is described a method by which information portals may be personalised to present integrated conventional content as well as relevant applications to users.

The invention is not restricted to the details of the foregoing embodiment(s).

Although the features indicated in the drawings and described herein are typically implemented in software, and as such represent software entities, such as software modules or objects, it will be appreciated that, where appropriate, such software entities may be replaced by hardware equivalents.

1. A meta data category specifying types of web applications and services.

2. A meta data category according to claim 1, wherein said meta data category comprises a plurality of functional identifiers, each functional identifier denoting a specific type of application or service available via the world wide web.

3. The meta data category of claim 2, wherein each functional identifier comprises one or more keywords identifying a type of application or service being offered by a web based provider.

4. The meta data category of claim 2, wherein each functional identifier is written in a task description language describing the functionality of the application or service.

5. The meta data category of claim 1, wherein the category is provided in a searchable area of a web page.

6. A method of building up a portal to information and applications on a network comprising:
retrieving content from one or more data sources, and
presenting the retrieved content to a user's web browser (216), wherein the retrieved content presented to a user includes information concerning web applications and/or services, said information being retrieved on the basis of a dedicated and searchable meta data category relating to web application and/or service types.

7. The method of claim 6, further comprising analysing an input user query to detect a desire for retrieving web applications and/or services, retrieving content from one or more data sources that match the user query and presenting the retrieved content to the user's web browser (216).

8. A method according to claim 6, wherein the step of retrieving content from data sources comprises filtering content and applications from said one or more data sources to match such content with a user query or user profile (226).

9. A method according to claim 6, wherein the web browser (216) is configured to deliver information to the user based on a user profile (226), so as to personalise the portal.

10. A method according to claim 9, wherein the user profile (226) is constructed based upon implicit feedback from information originating from the user and delivered by the browser (216).

11. A method according to claim 6, wherein in the step of retrieving content, said content is retrieved based directly upon a user query and such content includes one or more links to application and/or service providers identified by said one or more functional identifiers.

12. A computer program product (200) being arranged for causing a processor to execute the method of any of claims 6 to 11.
